(19) United States
(12) Patent Application Publication
(10) Pub. No.: US 2015/0308384 A1
(43) Pub. Date: Oct. 29, 2015

(54) PROPULSION ASSEMBLY FOR ROCKET

(71) Applicants: SNECMA, Paris (FR); CENTRE NATIONAL D'ETUDES SPATIALES CNES, Paris (FR)

(72) Inventors: Jean-Luc BARTHOULOT, Panilleuse (FR); Jean-Marie CONRARDY, Courcelles-Sur-Seine (FR); Gaelle LE BOUAR, Saint-Marcel (FR)

(73) Assignee: SNECMA, Paris (FR)

(21) Appl. No.: 14/648,411

(22) PCT Filed: Nov. 28, 2013
(86) PCT No.: PCT/FR13/52892

§ 371 Date: May 29, 2015

(30) Foreign Application Priority Data
Nov. 30, 2012 (FR) 1261466

(51) Int. Cl. F02K 9/48; F02K 9/58; F02K 9/44

(52) U.S. Cl. CPC F02K 9/48; F02K 9/44; F02K 9/58

(57) ABSTRACT

A propulsion assembly for a rocket including a tank for liquid oxygen, an engine having a combustion chamber, and a “heater” heat exchanger suitable for vaporizing liquid oxygen. The assembly has a vaporized oxygen circuit suitable for directing the oxygen vaporized by the heater either to the combustion chamber or to the tank. When the vaporized oxygen is directed to the combustion chamber, the engine advantageously develops low thrust.

The invention relates to a propulsion assembly for a rocket comprising a tank for liquid oxygen, an engine having a combustion chamber, and a “heater” heat exchanger suitable for vaporizing liquid oxygen.

The engine is usually an engine in which the gas from the combustion chamber is exhausted via a nozzle so as to develop thrust.

In general, in such propulsion assemblies, it is necessary to maintain the liquid oxygen tank under pressure in order to ensure that the liquid oxygen that is directed to the engine flows at a regular rate. Pressure is maintained either by injecting helium into the gas space at the top of the tank, or by injecting oxygen in the vapor phase as obtained by vaporizing liquid oxygen in a heat exchanger.

The invention relates in particular to a specific propulsion assembly that is required, in a so-called “low-thrust” mode of operation, to apply acceleration to the rocket in which it is mounted that is considerably smaller than the nominal maximum thrust that it is capable of applying to the rocket.

Such a propulsion assembly is generally designed to perform the following stages of flight:

During a first stage of operation of the engine, it applies predetermined acceleration to the rocket so as to enable the rocket to reach a predetermined position and speed in orbit. This acceleration is generally transmitted to the rocket by causing the propulsion assembly to operate in a “normal” mode of operation in which the engine develops the nominal maximum thrust for which it is designed.

Once the rocket has reached the desired position and speed in orbit, the satellite(s) or other payloads conveyed on board the rocket is/are delivered.

In a second stage of operation of the engine, it serves to return the rocket to earth so that it does not clutter space outside the atmosphere. During this return of the rocket to earth, it is necessary to guide the rocket to the intended zone for landing (usually at sea).

During this return stage, the mass of the rocket is much less than it was before delivering the satellite. In addition, the force of gravity tends to accelerate the rocket rather than to slow it down. Consequently, in order to ensure that the thrust from the engine enables the rocket to be guided and that the rocket remains controllable, it is necessary during the return stage for the engine to apply acceleration to the rocket that is considerably smaller than the nominal maximum thrust.

In addition, the flight plan of the rocket may also include certain orbital maneuvers, for the purpose of changing the orbit of the rocket after it has joined a first orbit. During these maneuvers, and for the reasons given above, the thrust required of the rocket engine is considerably smaller than the nominal maximum thrust.

Until now, propulsion assemblies of the type presented in the introduction have been caused to deliver low thrust mainly by reducing the rate at which propellants are fed to the engine.

Nevertheless, it is found that when the flow rate of a propellant becomes very low, oscillatory phenomena can appear between the combustion chamber and the propellant feed circuits connecting the propellant tank to the combustion chamber. These oscillatory phenomena give rise to large fluctuations in the thrust from the engine, which fluctuations are naturally harmful to guiding the rocket during the return stage.

In order to avoid these oscillatory phenomena, particularly when the propellant under consideration is oxygen and the engine is arranged in its nominal maximum thrust mode of operation to inject oxygen into the combustion chamber via the injectors in the liquid phase, the remedy that has been applied consists in injecting oxygen into the engine not in the liquid phase, but rather in the vapor phase. It has been found that this measure reduces the oscillatory phenomena considerably.

Nevertheless, in order to achieve this result, it has been necessary to add an additional heater to the engine in order to vaporize the oxygen. This modification thus leads to additional weight, cost, and complexity in the rocket, which it would be desirable to avoid.

The object of the invention is thus to propose a propulsion assembly of the type presented in the introduction that has better performance, e.g. in terms of weight, complexity, and/or price, etc., than propulsion assemblies of known types, and that satisfies the following requirements:
being suitable for operating in a “normal” mode, in which the engine applies a nominal maximum thrust to the rocket in which it is mounted;
also being suitable for operating in a “low-thrust” mode in which the engine applies low thrust to the rocket that is considerably smaller than the nominal maximum thrust;
while also avoiding the appearance of oscillatory phenomena in the propellant feed circuits of the propulsion assembly.

This object is achieved by a propulsion assembly of the type presented in the introduction by the fact that the propulsion assembly includes a vaporized oxygen circuit suitable in a first mode of operation (referred to as a “low-thrust” mode of operation) for directing the oxygen vaporized by the heater solely to the combustion chamber; and in a second mode of operation (referred to as the “high-thrust” mode of operation) to direct it solely to the tank.

Thus, in the propulsion assembly, a single heat exchanger, referred to as a heater, serves first in low-thrust operation to vaporize the oxygen for feeding the engine with oxygen in the vapor phase, and secondly in normal high-thrust operation to maintain a constant pressure in the oxygen tank. The invention thus advantageously enables these two functions to be provided, and thus enables these two modes of operation to be performed, while using the same heater. Concerning the energy absorbed by the heater, the engine is usually arranged in such a manner that the energy used in the heater for vaporizing the oxygen is taken from the exhaust gas from the engine. The term “exhaust gas” is used herein to mean any of the gas produced in the combustion chamber of the engine.

On leaving the heater, the oxygen vaporized by the heater is distributed by the vaporized oxygen circuit.

In one embodiment, this circuit is arranged as follows: the propulsion assembly has a main pipe for feeding the engine with oxygen, which pipe connects the tank to the combustion chamber in order to enable the engine to be fed with liquid oxygen; and the vaporized oxygen circuit includes valve means enabling the combustion chamber to be connected selectively either to said main pipe in order to enable it to be fed with liquid oxygen, or else to the vaporized oxygen circuit in order to enable it to be fed with vaporized oxygen.

In an embodiment, the vaporized oxygen circuit has valve means for directing the vaporized oxygen selectively either to the tank or to the combustion chamber, but not to both at the same time. It has been found that in low-thrust operation, there is no need to maintain a constant pressure in the oxygen tank.

As valve means, the oxygen circuit may thus include a three-port valve suitable for directing the stream of vaporized oxygen coming from the heater either to the combustion chamber, or to the tank.

Furthermore, the vaporized oxygen circuit may include a circuit portion in parallel between upstream and downstream tapping points arranged on the main pipe. This embodiment advantageously enables the upstream and downstream portions of the main pipe that are situated respectively upstream and downstream from the tapping point in the vaporized oxygen circuit to be used for transferring liquid oxygen in normal operation, and vaporized oxygen in low-pressure operation.

In parallel with providing a flow of vaporized oxygen, various provisions can be adopted for regulating the feed of liquid oxygen to the engine. In one embodiment, the engine may include a liquid oxygen valve arranged in the main pipe between the upstream and downstream tapping points, and enabling the main pipe to be opened or closed. Closing the liquid oxygen valve makes it possible to ensure in the low-thrust mode of operation that only vaporized oxygen is injected into the engine.

The propulsion assembly of the invention may have various types of engine.

The propulsion assembly may thus be based on a tap-off type engine, i.e. an engine in which exhaust gas is taken to deliver energy (in heat and/or mechanical form) to certain portions of the engine.

In an embodiment, the heater is a heat exchanger for exchanging heat between oxygen and exhaust gas from the engine. The heater may be arranged in various locations.

Firstly, it may be arranged at least in part in a wall of the combustion chamber and/or an ejection nozzle of the engine. Nevertheless, it may also be arranged at a distance from the combustion chamber and the ejection nozzle of the engine. Under such circumstances, the propulsion assembly has an exhaust gas circuit for taking exhaust gas from the engine and transporting it to the heater. Advantageously, the exhaust gas circuit also enables the exhaust gas that has been taken off to be injected into at least one turbine, in order to drive it. The turbine(s) may be in turbopumps for feeding the engine with propellant, for example oxygen and hydrogen feed turbopumps.

When the taken-off exhaust gas is used for driving a turbine, the heat exchanger is preferably situated downstream from said at least one turbine in the exhaust gas take-off circuit.

When the taken-off exhaust gas is used for actuating one or more turbines, the propulsion assembly may also include a bypass pipe connecting together two points of the exhaust gas circuit that are situated respectively upstream and downstream of said at least one turbine. The bypass pipe should then be capable of being opened or closed by means of one or more valves depending on the mode of operation of the engine: it must be capable of being closed to enable the turbines to be driven by the taken-off exhaust gas, and it must be capable of being open to avoid driving the turbine.

The propulsion assembly may also be based on an expander type engine, i.e. an engine in which a heat-transfer fluid, in particular a propellant (hydrogen in this example) is taken and vaporized in order to deliver energy (in heat and/or mechanical form) to certain portions of the engine.

Thus, the propulsion assembly may include a heat-transfer fluid flow circuit having a primary heat exchanger enabling heat energy from the exhaust gas to be delivered to the heat-transfer fluid, and also the heater, which heater constitutes a secondary heat exchanger enabling heat energy from the heat-transfer fluid to be delivered to the oxygen. The use of an intermediate heat-transfer fluid provides flexibility in the arrangement of the heater and of the vaporized oxygen circuit.

The heat-transfer fluid may serve to transfer energy not only in heat form, but also in mechanical form.

For this purpose, in the propulsion assembly, the primary heat exchanger is suitable for vaporizing the heat-transfer fluid; and the heat-transfer fluid flow circuit may enable the vaporized heat-transfer fluid to be injected into at least one turbine in order to drive it. Vaporizing the heat-transfer fluid advantageously enables a fluid under pressure to be made available; the energy delivered to the heat-transfer fluid can then be recovered via one or more turbines. The turbine(s) may in particular be parts of turbopumps in propellant feed circuits of the engine.

Preferably, the heat-transfer fluid is another propellant consumed by the engine, e.g. hydrogen.

The invention can be well understood and its advantages appear better on reading the following detailed description of embodiments given as non-limiting examples. The description refers to the accompanying drawings, in which:

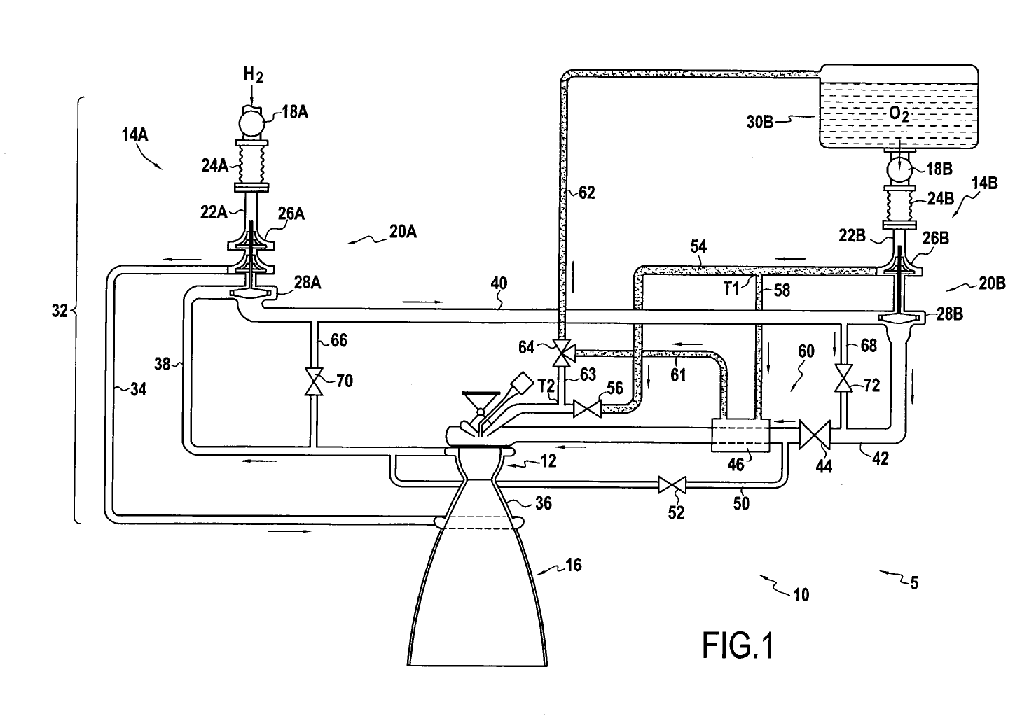

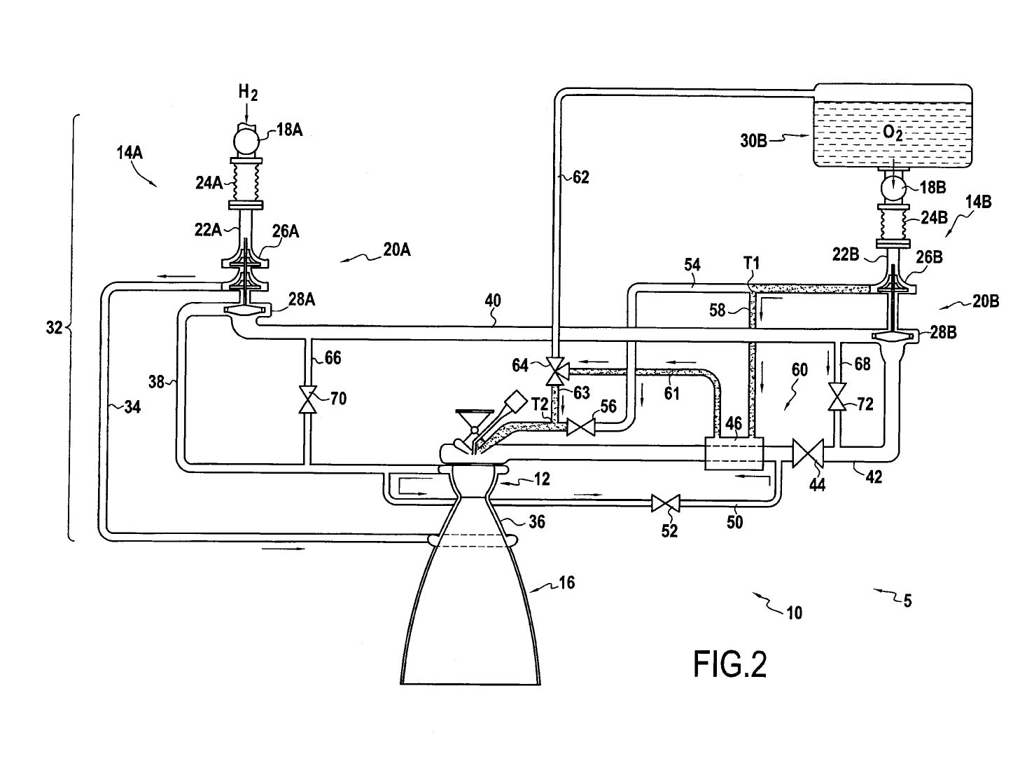

FIGS. 1 and 2 are diagrammatic views of a first propulsion assembly of the invention comprising an expander type engine shown respectively in normal operation and in low-thrust operation; and

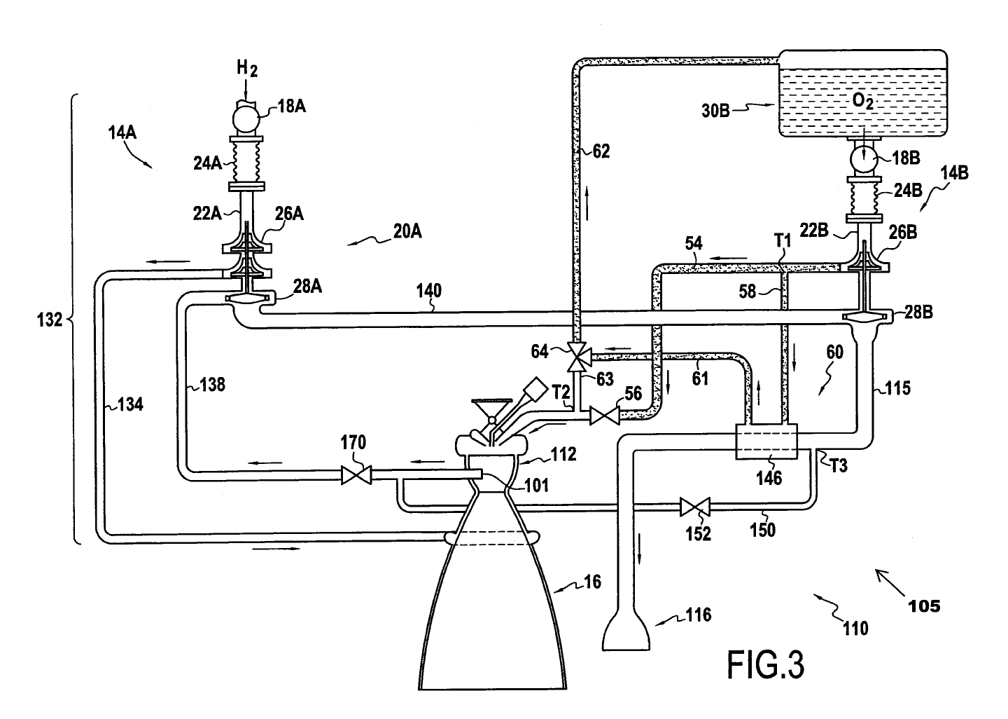

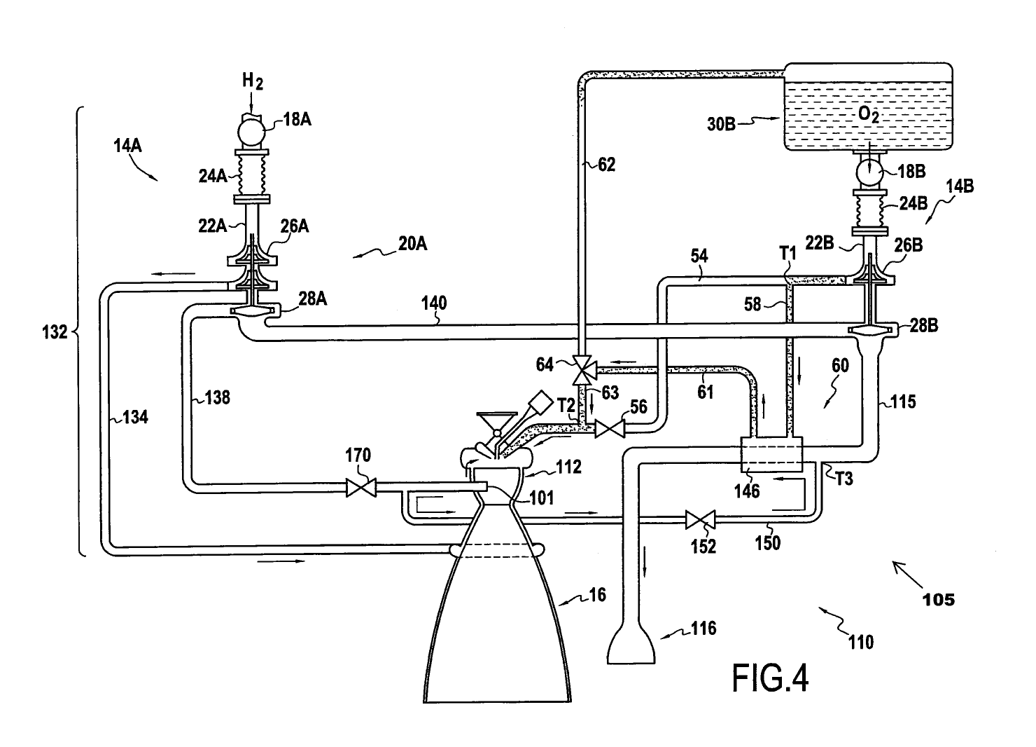

FIGS. 3 and 4 are diagrammatic views of a second propulsion assembly of the invention comprising a tap-off engine respectively in normal operation and in low-thrust operation.

With reference to FIG. 1, there follows a description of a propulsion assembly 5 including a rocket engine 10.

The propulsion assembly 5 comprises a hydrogen tank (30A) not shown, an oxygen tank 30B, a “heater” heat exchanger 46, a fluid distribution circuit 32, and an engine 10.

The engine 10 is a so-called “expander” engine. In such an engine, a fuel and an oxidizer are burnt in a combustion chamber prior to being ejected via a nozzle. In the example shown, the fuel is hydrogen and the oxidizer is oxygen; fuels other than hydrogen can be used in the context of the invention.

The functional portions of the engine 10 comprise in particular a combustion chamber 12, and a nozzle 16 having a diverging cone.

The fluid distribution circuit 32 has two engine feed circuits 14A and 14B for feeding the engine respectively with liquid hydrogen and liquid oxygen, together with a vaporized oxygen circuit for performing a function that is described below.

The upstream portions of the two feed circuits 14A and 14B are similar: each has a booster pump (18A, 18B), a flexible segment (24A, 24B), and a feed pipe (22A, 22B) connecting the tank (tanks 30A, 30B) to respective turbopumps (20A, 20B).

In a similar embodiment, the feed circuits could be made without the booster pumps 18A and 18B.

The two turbopumps 20A and 20B are thus fed respectively with liquid hydrogen and liquid oxygen coming from the tanks 30A and 30B via the upstream portions of the feed circuits 14A and 14B.

The turbopumps 20A and 20B are pumps of known types respectively for hydrogen and for oxygen. Each of them comprises a pump (pumps 26A, 26B) associated with a turbine (turbines 28A, 28B). The pump 26A is a two-stage pump, whereas the pump 26B has only one stage. The pumps 26A and 26B serve respectively to pump the hydrogen and the oxygen from the tanks 30A and 30B in which they are stored so as to inject them into the engine 10 via the downstream portions of the feed circuits 14A and 14B. The oxygen tank 30B of the propulsion assembly thus feeds the combustion chamber 12 with liquid oxygen via the feed circuit 14B.

The respective arrangements of the feed circuits 14A and 14B are described in greater detail below.

### Hydrogen Circuit

The pump 26A delivers liquid hydrogen via a pipe 34 to the heat exchanger 36 (a primary heat exchanger) that is arranged in the wall of the nozzle 16 and of the combustion chamber 12.

In the heat exchanger 36, hydrogen flows in contact with the nozzle 16 and with the combustion chamber 12. Under the effect of the heat, the hydrogen vaporizes. At the outlet from the heat exchanger 36, the stream of vaporized hydrogen is directed via a pipe 38 to the turbine 28A of the turbopump 20A. The pressure of the hydrogen flowing through the turbine 28A drives the pump 26A.

On leaving the turbine 28A, the vaporized hydrogen is directed via a pipe 40 to an admission orifice of the turbine 28B. The pressure of the hydrogen flowing through the turbine 28B then drives the pump 26B.

On leaving the turbine 28B, the vaporized hydrogen is directed via a pipe 42, a valve 44, and the heat exchanger 46 (a secondary heat exchanger) to the engine 10. The hydrogen is then injected into the combustion chamber 12. The circuit 14A for feeding the engine with hydrogen thus comprises in succession the pipe 34, the heat exchanger 36, and the pipes 38, 40, and 42.

In addition, a bypass pipe 50 having a valve 52 connects the pipe 38 to a tapping point provided on the pipe 42 and arranged between the valve 44 and the heater 46. Furthermore, in order to allow the turbines 28A and 28B to be bypassed, the circuit 32 has bypass pipes 66 and 68 provided with respective valves 70 and 72. These pipes respectively interconnect the admission and delivery orifices of the turbines 28A and 28B. The purpose of the pipes 50, 66, and 68, and of the valves 52, 70, and 72 is described in detail below.

### Oxygen Circuit

The pump 26B delivers liquid oxygen into a “main” pipe 54 on which there is arranged a stop valve 56. The oxygen is taken via the pipe 54 to the engine 10 where it is injected into the combustion chamber 12.

### Vaporized Oxygen Circuit

The fluid distribution circuit 32 also has a vaporized oxygen circuit. The vaporized oxygen circuit is a circuit whereby liquid oxygen is taken and delivered to the heater 46 where it is vaporized prior to being taken either to the combustion chamber 12 or to the oxygen tank 30B depending on the mode of operation that is selected.

In order to minimize the size of the vaporized oxygen circuit, it is preferably made as a parallel circuit that is arranged between two tapping points on the main pipe. This is how the vaporized oxygen circuit 60 is made. It has an upstream parallel pipe 58 tapped to a tapping point T1 on the main pipe 54. The liquid oxygen taken from the pipe 54 is delivered by the pipe 58 to the heater 46 where it is vaporized.

The heater 46 operates as follows: the vaporized hydrogen, which is relatively hot (since it is vaporized and heated by the exhaust gas from the engine 10 in the heat exchanger 36) flows through the heater 46. This stream of hydrogen comes into contact with the cooler oxygen coming from the oxygen tank 30B. The heater 46 heats the stream of oxygen coming from the pipe 58 and vaporizes it.

The oxygen in vaporized form leaves the heater 46 via a pipe 61 and is injected into a three-port valve 64 referred to as a heater outlet valve (HOV). The valve 64 serves to direct the stream of vaporized oxygen either to the gas space at the top of the tank 30B via a pipe 62, or to the oxygen injection pipe 54 and consequently to the engine 10, via a pipe 63. The pipe 63 joins the pipe 54 at a taping point (downstream tapping point) T2. The stop valve 56 of the pipe 54 is situated upstream from the tapping point T2.

### Operation of the Propulsion Assembly 5

FIG. 1 shows the operation of the engine operating in normal high-thrust mode, and FIG. 2 shows it operating in a “low-thrust” mode.

Under normal operating conditions, the valve 64 is positioned so that the vaporized oxygen leaving the heater 46 is directed to the gas space in the tank 30B via the pipe 62. Injecting oxygen in the vapor phase into the tank 30B serves to control the pressure that exists in the tank and thus to stabilize the feeding of oxygen to the engine 10. The flow rate in the pipe 63 is then zero. The valve 56 is open to enable the engine 10 to be fed with liquid oxygen, and the valve 44 is open to enable the engine 10 to be fed with liquid hydrogen. The valve 52 is closed and the flow rate in the pipes 50, 66, and 68 is zero. Thus, the vaporized hydrogen leaving the heat exchanger 36 transits via the turbines 28A and 28B prior to being injected into the engine 10 via the pipe 42. Consequently, the pressure of the vaporized hydrogen drives the turbines 28A and 28B and consequently drives the pumps 26A and 26B. During this stage, the positions of the valves 70 and 72 that make it possible to bypass the turbines 28A and 28B respectively, are controlled so as to govern the flow rate through these turbines in order to adjust the operation of the engine and regulate the thrust it delivers.

In contrast, under “low-thrust” conditions, the valve 64 is positioned so that the vaporized oxygen leaving the heater 46 is directed via the pipe 63 to the pipe 54 and only to the pipe 54. The engine 10 is thus fed with vaporized oxygen and only with vaporized oxygen since simultaneously the top valve 56 in the main pipe 54 is closed.

Furthermore, in this mode of operation, there is no need to drive the turbopumps 20A and 20B. The pumps 26A and 26B are operated solely under the effect of the fluid pressure coming from the tanks. They therefore deliver at rates that are relatively low, but sufficient for low-thrust operation.

In this mode of operation, the valve 44 is closed, which means that the turbines 28A and 28B are not fed with hydrogen. The valve 52 in the pipe 50 is open and it is thus via the pipe 50 that the vaporized hydrogen leaving the heat exchanger 36 joins the pipe 32 (with the flow rate remaining zero in the pipes 38 and 40). The vaporized hydrogen as injected in this way into the pipe 42 is introduced into the heat exchanger 46. It transfers some of its heat to the oxygen flowing therethrough and thereby vaporizes the oxygen flowing through the heat exchanger 46.

Simultaneously, the valve 56 of the pipe 54 is closed. Consequently, only the oxygen flowing in the vaporized oxygen circuit is injected into the engine 10, via the pipes 58, 61, and 63, and via the downstream segment of the pipe 54. As a result, only vaporized oxygen is injected into the engine 10.

Feeding the engine 10 with oxygen in the vapor phase is advantageous in that the stream of oxygen still has a volume flow rate that is sufficient to enable it to be regulated and stabilized, while nevertheless presenting a mass flow rate that is very low, thus enabling the power of the engine to be significantly reduced. It is thus possible to operate the engine 10 at a power level less than 75% of its nominal power.

In the engine 10, the oxygen is vaporized by the previously vaporized hydrogen. Hydrogen is available in the vapor phase because the engine is of the expander type and is designed to be fed with hydrogen in the vapor phase. In this engine the circuit (pipes 34 and 38, and heat exchangers 36 and 46) for distributing and vaporizing hydrogen constitutes a circuit for a flow of a heat transfer fluid, with hydrogen acting as the heat transfer fluid. This circuit enables heat energy from the exhaust gas to be transferred to the hydrogen and then transferred by the hydrogen to the oxygen.

Heat may also be imparted to the oxygen in order to vaporize it without using a heat transfer fluid, in particular in propulsion assemblies that have engines that are not of the expander type, but that are of the tap-off type, for example. In such engines, a fraction of the exhaust gas is taken off to deliver heat to various members of the engine.

By way of example, there follows a description with reference to FIGS. 3 and 4 of a propulsion assembly 105 of the invention. Unless specified to the contrary, the propulsion assembly 105 is identical to the propulsion assembly 5. Consequently, the description relates only to the characteristics of the propulsion assembly 105 that differ from the propulsion assembly 5. Furthermore, elements that are identical or that are similar are given the same references in both embodiments of the invention.

As in the propulsion assembly 5, the propulsion assembly 105 has a hydrogen tank (30A) not shown, an oxygen tank 30B, a heater 146, a fluid distribution circuit 132, and an engine 110.

The hydrogen and oxygen tanks 30B, and the upstream portions of the feed circuits 14A and 14B are identical in the assembly 105 and in the assembly 5.

### Hydrogen Circuit

The pump 26A delivers liquid hydrogen via a pipe 34 to the heat exchanger 136. It is identical to the heat exchanger 36 except that the stream of vaporized hydrogen leaving the heat exchanger 136 is not directed to the turbine 28A via the pipe 38 (assembly 5), but is injected directly into the combustion chamber 12 of the engine 10.

### Exhaust Gas Circuit

The assembly 5 also has an exhaust gas circuit. This circuit includes one or more upstream take-off orifices 101 enabling a fraction of the exhaust gas to be taken from the combustion chamber 12 (exhaust gas could equally well be taken from the nozzle 16). The gas that is taken off passes via a pipe 138 including a valve 170 to a turbine 28A. At the outlet from this turbine, a pipe 140 takes the exhaust gas to the turbine 28B. The exhaust gas circuit thus serves to drive the turbines 28A and 28B and consequently the pumps 20A and 20B. At the outlet from the turbine 28B, the exhaust gas is taken by a pipe 115 to an external exhaust orifice 116.

The heater 146 is interposed on the pipe 115. Like the heater 46, it serves to vaporize the liquid hydrogen passing therethrough; nevertheless, the heater 146 takes heat from the exhaust gas flowing in the pipe 115, and not from vaporized hydrogen.

A bypass pipe 150 having a valve 152 serves to connect the pipe 138 to a tapping point T3 provided on the pipe 115 and arranged upstream from the heater 46. The operation of the pipe 150 and of the valve 152 are described in detail below.

### Oxygen Circuit and Vaporized Oxygen Circuit

These circuits are substantially identical to those of the propulsion assembly 5, except that the heater 46 (oxygen/hydrogen) is replaced by a heater 146 (oxygen/exhaust gas).

The operation of the assembly 105 is generally much the same as that of the assembly 5.

The main difference is that in normal operation, the turbines 28A and 28B are driven by the pressure of the exhaust gas flowing in the exhaust gas circuit, and not by the pressure of the hydrogen vaporized by the heat exchanger 36 (the vaporized hydrogen is injected directly into the engine 10). The same exhaust gas advantageously also serves to vaporize the oxygen and thus to ensure constant pressure in the oxygen tank 30B.

In low-thrust operation, oxygen is likewise vaporized by the exhaust gas of the exhaust gas circuit. Nevertheless, in this mode of operation, the exhaust gas is not used to drive the turbines 28A and 28B. The valve 152 is open, while the valve 170 is closed. As a result, the pipes 138 and 140 no longer cause any exhaust gas to flow through the turbines 28A and 28B. The exhaust gas flows directly via the pipe 150 from the exhaust gas takeoff orifices in the combustion chamber 12 to the tapping point T3 of the pipe 115. Prior to being ejected via the orifice 116, the exhaust gas thus performs the function of vaporizing oxygen, thereby enabling the engine 110 to be fed with vaporized oxygen.

1-11. (canceled)

12. A propulsion assembly for a rocket comprising a tank for liquid oxygen, an engine having a combustion chamber, and a heater heat exchanger suitable for vaporizing liquid oxygen, wherein the assembly comprises a vaporized oxygen circuit suitable in a first mode of operation for directing the oxygen vaporized by the heater solely to the combustion chamber; and in a second mode of operation for directing it solely to the tank.

13. A propulsion assembly according to claim 12, having a main pipe for feeding the engine with oxygen, which pipe is suitable for connecting the tank to the combustion chamber in order to enable the engine to be fed with liquid oxygen; and wherein the vaporized oxygen circuit comprises valve means enabling the combustion chamber to be connected selectively either to said main pipe in order to enable it to be fed with liquid oxygen, or else to the vaporized oxygen circuit in order to enable it to be fed with vaporized oxygen.

14. A propulsion assembly according to claim 12, having a main pipe for feeding the engine with oxygen, which pipe is suitable for connecting the tank to the combustion chamber in order to enable the engine to be fed with liquid oxygen; and wherein the vaporized oxygen circuit comprises a circuit portion arranged as a parallel connection between upstream and downstream tapping points arranged on the main pipe.

15. A propulsion assembly according to claim 14, wherein the engine comprises a liquid oxygen valve arranged in the main pipe between said upstream and downstream tapping points, and enabling the main pipe to be opened or closed.

16. A propulsion assembly according to claim 12, wherein the oxygen circuit comprises a three-port valve suitable for directing the stream of vaporized oxygen coming from the heater either to the combustion chamber, or to the tank.

17. A propulsion assembly according to claim 12, wherein the heater is a heat exchanger for exchanging heat between oxygen and exhaust gas from the engine.

18. A propulsion assembly according to claim 17, in which the heater is arranged at a distance from the combustion chamber and from an ejection nozzle of the engine.

19. A propulsion assembly according to claim 12, comprising an exhaust gas circuit suitable for injecting exhaust gas into at least one turbine in order to drive it.

20. A propulsion assembly according to claim 12, comprising a heat-transfer fluid flow circuit having a primary heat exchanger enabling heat energy from the exhaust gas to be delivered to the heat-transfer fluid, and also the heater, which heater constitutes a secondary heat exchanger enabling heat energy from the heat-transfer fluid to be delivered to the oxygen.

21. A propulsion assembly according to claim 20, wherein the primary heat exchanger is suitable for vaporizing the heat-transfer fluid, and a heat-transfer fluid flow circuit enables the vaporized heat-transfer fluid to be injected into at least one turbine in order to drive it.

22. A propulsion assembly according to claim 20, wherein the heat-transfer fluid is another propellant consumed by the engine.

23. A propulsion assembly according to claim 21, wherein the heat-transfer fluid is another propellant consumed by the engine.

24. A propulsion assembly according to claim 22, wherein the heat-transfer fluid is hydrogen.

25. A propulsion assembly according to claim 23, wherein the heat-transfer fluid is hydrogen.
